(19) United States
(12) Patent Application Publication
(10) Pub. No.: US 2026/0298677 A1
(43) Pub. Date: Oct. 1, 2026

(54) ROTARY OPTICAL ENCODER DEVICES FOR OPTICAL FLOW SENSING, AND RELATED SENSORS AND METHODS

(71) Applicant: PRECISION PLANTING LLC, Tremont, IL (US)

(72) Inventors: Dan BJERTNESS, Fargo, ND (US); Michael EHRESMANN, Fargo, ND (US); Kory WECKMAN, Fargo, ND (US)

(21) Appl. No.: 19/480,662

(22) PCT Filed: Apr. 18, 2024
(86) PCT No.: PCT/IB2024/053781

§ 371 Date: Oct. 31, 2025

Related U.S. Application Data
(60) Provisional application No. 63/500,536, filed on May 5, 2023.

(51) Int. Cl. G01F 1/10; A01M 7/00; G01D 5/347; G01F 15/061

(52) U.S. Cl. CPC G01F 1/103; A01M 7/0089; G01D 5/3473; G01F 15/061

(57) ABSTRACT

An optical flow rate sensor system for a sprayer includes an optical sensor, an optical sensor window within a display housing, a rotary optical encoder device within a drum housing, and vortexing geometry upstream of the encoder device. The optical sensor is located adjacent to the optical sensor window. The encoder device has a unitary body, which comprises a main portion, a first tab portion, and a second tab portion. The encoder device is configured to revolve around an axis of the drum housing.

### CROSS-REFERENCE TO RELATED APPLICATIONS

This application claims the benefit of the filing date of U.S. Provisional Patent Application 63/500,536, “Projectiles for Optical Flow Sensing, and Related Sensors and Methods,” filed May 5, 2023, the entire disclosure of which is incorporated herein by reference.

### TECHNICAL FIELD

The present disclosure relates generally to agricultural sprayers, and more specifically to an optical sensor system for measuring the flow rate of an agricultural sprayer.

### BACKGROUND

It is desirable to measure the flow rate of an agricultural sprayer to monitor the amount of fluid, such as a pesticide, being sprayed in a particular area and ensure spray nozzle integrity. Overuse of pesticides can lead to product waste and adverse environmental outcomes, while underuse of pesticides can cause an area to be inadequately treated and, in some instances, can contribute to increasing pesticide resistance.

### BRIEF SUMMARY

A rotary optical encoder device for an optical sensor has a unitary body, which comprises a main portion, a first tab portion, and a second tab portion. The main portion defines a first arcuate surface on a first side of the main portion and a second arcuate surface on a second opposite side of the main portion. The first tab portion extends from the second opposite side of the main portion proximate a first longitudinal end of the main portion. The first tab portion has a first inner surface and a first outer surface. The first outer surface extends from the first arcuate surface at the first longitudinal end of the main portion. The second tab portion extends from the second opposite side of the main portion proximate a second longitudinal end of the main portion. The second tab portion has a second inner surface and a second outer surface. The second outer surface extends from the first arcuate surface at the second longitudinal end of the main portion. The second arcuate surface of the main portion extends between the first inner surface and the second inner surface.

In certain embodiments, the first tab portion has a first transmittance or reflectance at a preselected wavelength and the second tab portion has a second transmittance or reflectance at the preselected wavelength. The second transmittance or reflectance is different from the first transmittance or reflectance.

The first tab portion may comprise a first material having a first composition, and the second tab portion may comprise a second material having a second composition different from the first composition. For example, the first material and the second material may each be plastics, ceramics, and/or metals. For example, the first material may comprise an opaque material, and the second material may comprise a translucent material.

The first outer surface and the second outer surface portion may define an acute angle therebetween. The first inner surface and the second inner surface may define an acute angle therebetween. The first inner surface may face the second inner surface.

An optical flow rate sensor system for an agricultural sprayer includes a drum housing and a central passage housing together defining a first flow path comprising a first portion generally parallel to an axis and a second vortex portion around the axis, an optical sensor disposed facing the axis, an optical sensor window within a display housing and disposed between the axis and the optical sensor, and a rotary optical encoder device within the drum housing and configured to revolve around the axis when fluid flows through the first flow path.

The central passage housing may define a second flow path generally parallel to, and in an opposite direction of, the first flow path.

The drum housing may comprise an inner surface and at least one interior wall which extends from the inner surface. The interior wall extends circumferentially about a circumference of the inner surface and axially parallel to the axis such that the interior wall defines the second vortex portion of the first flow path.

Another embodiment includes a method of testing an optical flow rate sensor system for an agricultural sprayer. The method includes directing, with a drum housing and a central passage housing, a fluid along a vortex flow path within the drum housing and around an axis. A rotary optical encoder device revolves within the drum housing and around the axis. An optical sensor emits a light beam through an optical sensor window and toward the axis. A portion of the light beam is reflected by the rotary optical encoder device. The optical sensor receives the portion of the light beam reflected by the rotary optical encoder device. The optical sensor communicates data about the reflected light to a controller. The controller generates transmittance data and absorption data about the fluid and the rotary optical encoder device. The controller assesses a speed of the rotary optical encoder device about the axis to calculate a flow rate of the fluid along the vortex flow path.

The fluid may be directed along the vortex flow path such that the fluid drives revolution of the rotary optical encoder device around the axis within the drum housing.

The light beam may be reflected by a first section of the rotary optical encoder device and a second section of the rotary optical encoder device, wherein the first section has a first optical absorption value and the second section has a second optical absorption value that is different from the first optical absorption value. At least one of transmittance data and absorption data may be generated about each of the first section and the second section.

An optical signature of the rotary optical encoder device may be analyzed. For example, the optical sensor may communicate data about the portion of the light beam reflected by the rotary optical encoder device to an oscilloscope. The controller may communicate the flow rate of the fluid along the vortex flow path to a display. The method optionally includes displaying, with the display, the flow rate of the fluid along the vortex flow path.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

While the specification concludes with claims particularly pointing out and distinctly claiming what are regarded as embodiments of the present disclosure, various features and advantages may be more readily ascertained from the following description of example embodiments when read in conjunction with the accompanying drawings.

FIG. 1A is a front perspective view of an optical flow rate sensor system.

FIG. 1B is a cross-sectional view of the system of FIG. 1A along a central plane.

FIG. 1C is a schematic depiction of an optical sensor and controller.

FIG. 2 is a cross-sectional view of the system of FIG. 1A taken orthogonal to the cross-sectional view of FIG. 1B.

FIG. 3A is a first perspective view of a portion of the sensor system of FIG. 1A.

FIG. 3B is a second perspective view of the portion of the sensor system of FIG. 1A.

FIG. 4A is a side view of a bi-sectional rotary optical encoder device.

FIG. 4B is a back view of the bi-sectional rotary optical encoder device of FIG. 4A.

FIG. 4C is a perspective view of the bi-sectional rotary optical encoder device of FIG. 4A.

### DETAILED DESCRIPTION

The illustrations presented herein are not actual views of any sensor or portion thereof, but are merely idealized representations to describe example embodiments of the present disclosure. Additionally, elements common between figures may retain the same numerical designation.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all the elements that form a complete structure or assembly. Only those process acts and structures necessary to understand the embodiments of the disclosure are described in detail below. Additional conventional acts and structures may be used. The drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

As used herein, the term “about” used in reference to a given parameter is inclusive of the stated value and has the meaning dictated by the context (e.g., it includes the degree of error associated with measurement of the given parameter).

As used throughout, ranges are used as shorthand for describing each and every value that is within the range. Any value within the range can be selected as the terminus of the range.

An optical flow rate sensor for a sprayer uses an arc-shaped encoder device in combination with a vortexing geometry to measure the flow rate of a fluid through the sprayer. The arc-shaped encoder device includes at least two sections with dissimilar transmittance and absorption values, which provides a lower-noise optical signal than a uniform encoder device and allows for more accurate readings across a wide range of fluid opacity. The vortexing geometry is provided by the shape of a section of the sprayer, and creates a vortex flow that allows for more accurate readings across a wide range of fluid flow rates.

During testing of the optical sensor, a test fluid is passed through the sprayer. This test fluid can have an amount of clay present in it to test the optical sensor's readings of the flow rate at a particular opacity. The amount of clay in the test fluid can be varied to check the optical sensor's readings across a range of fluid opacities. A consistent reading from the optical sensor (i.e., a fairly constant flow rate reading across a range of fluid opacities) would signal that the optical sensor is calibrated properly and producing accurate measurements. As described in further detail below, the use of an encoder device which is uniform in color can lead to a low signal-to-noise ratio at some fluid opacities, making it difficult to discern if the optical sensor is calibrated properly. An encoder device which contains two or more sections which have different optical transmittance/absorption values can increase the signal-to-noise ratio at these fluid opacities, allowing the optical sensor to produce accurate flow rate measurements across the tested range of opacities. The characteristic optical signature of a multi-sectional encoder device improves signal strength relative to noise, permitting more accurate measurements despite fluid opacity.

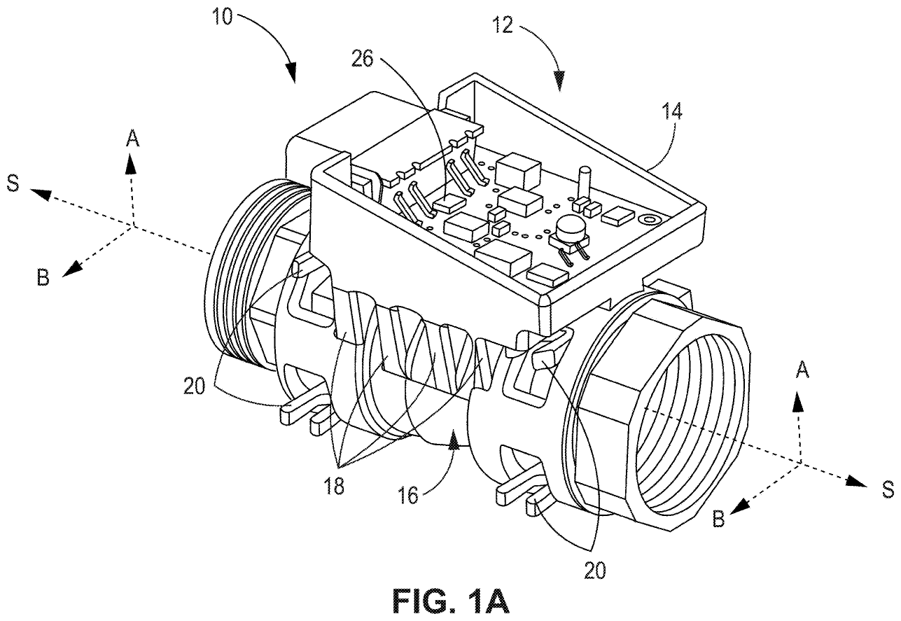

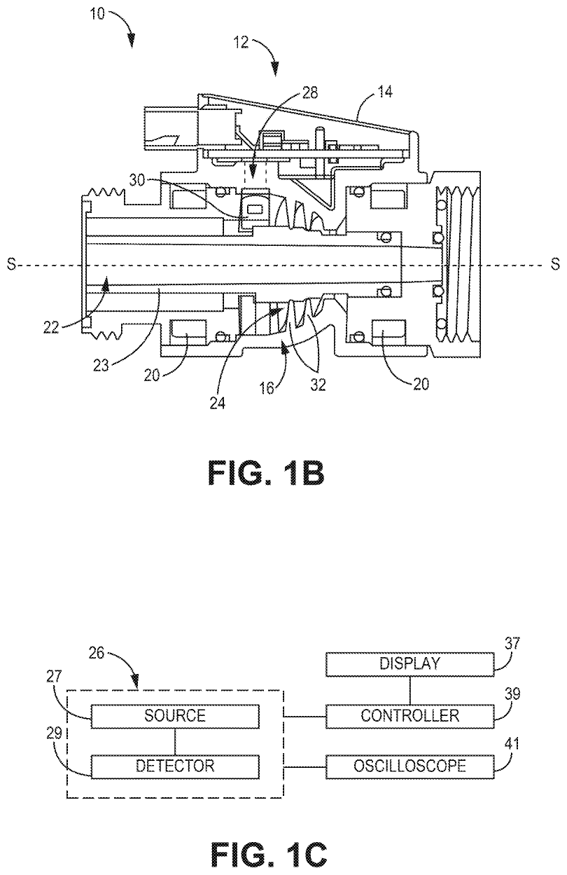

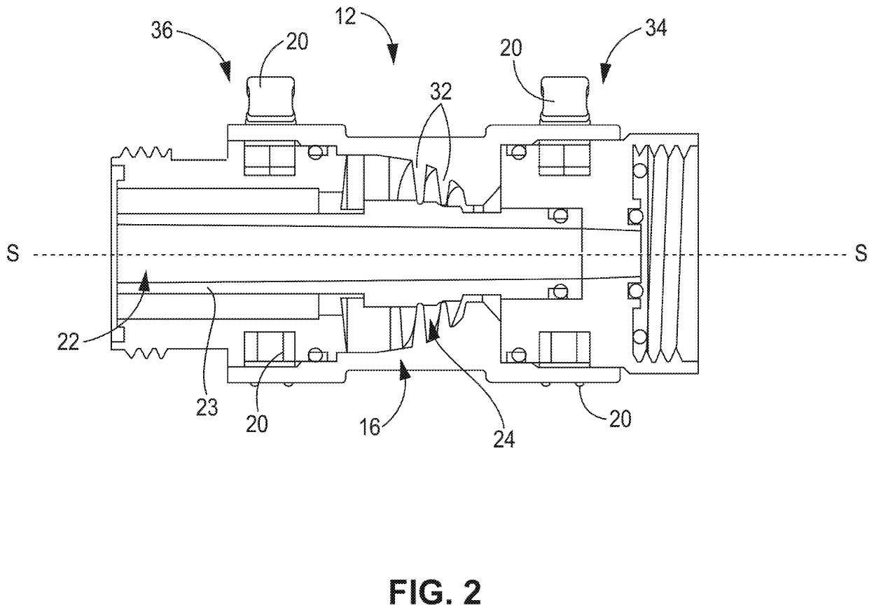

FIG. 1A is a perspective view of an optical flow rate sensor system 10 including an optical sensor 26. FIG. 1B is a cross-sectional view of sensor system 10 taken along plane A-A. FIG. 1C is a schematic depiction of optical sensor 26. FIG. 2 is a cross-sectional view of sensor system 10 of FIG. 1A taken along plane B-B, which is orthogonal to plane A-A. Sensor system 10 includes optical sensor section 12, display housing 14, drum housing 16, splines 18, clips 20, and central passage housing 23. Optical sensor section 12 includes optical sensor 26, optical sensor window 28, and encoder device 30. Drum housing 16 has interior walls 32 defining a vortex flow path 24. Drum housing 16 includes first end 34 and second end 36. Sensor system 10 is oriented along axis S-S, which is in plane A-A. Sensor system 10 can additionally include a controller, such as controller 39 (shown in FIG. 1C).

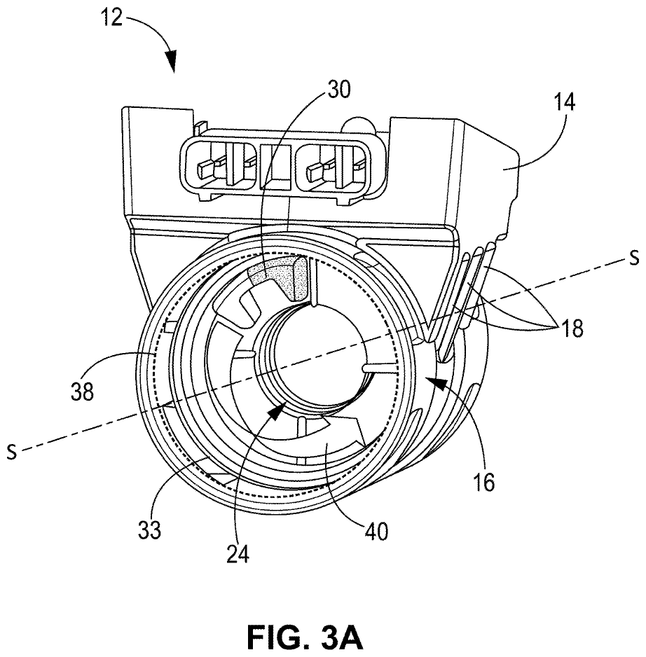

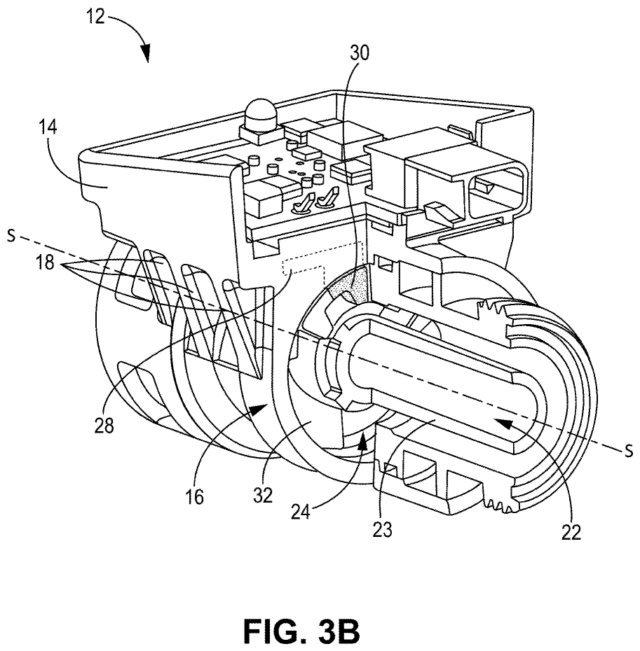

The axial direction of fluid movement through sensor system 10 is along axis S-S, such that one or more flow paths through sensor system 10 define axis S-S. Optical sensor section 12 is oriented axially along axis S-S and can be located adjacent to a housing section that contains components for routing fluid towards a spray nozzle. Optical sensor section 12 includes the components of sensor system 10 which allow for the flow rate of a fluid within sensor system 10 to be measured with an optical sensor, such as optical sensor 26. Drum housing 16 extends axially along axis S-S and defines an approximately hemispheric interior shape. Drum housing 16 defines a cavity therein that defines the vortex flow path 24. Interior walls 32 extend from inner surface 33 of drum housing 16 (shown in FIG. 3A), and interior walls 32 can extend both circumferentially around inner surface 33 and axially along drum housing 16 with respect to axis S-S. In the example depicted in FIGS. 1A-2, interior walls 32 form a vortexing geometry within drum housing 16.

Display housing 14 can be mounted to drum housing 16 such that display housing 14 is adjacent to drum housing 16 and central passage housing 23 during operation of sensor system 10. Display housing 14 is configured to receive a display, such as display 37 (shown schematically in FIG. 1C). Display 37 can be a screen or other user interface device configured to communicate information about the operation of sensor system 10 to a user. This information can include flow rate of a fluid within sensor system 10. Optical sensor 26 can be located adjacent to a bottom side of display housing 14 with respect to the drum housing 16. Optical sensor window 28 can be an opening that extends through display housing 14 and drum housing 16. As described in more detail below, optical sensor 26 can be located adjacent to optical sensor window 28 such that optical sensor 26 can detect the movement of encoder device 30 within drum housing 16. In the example depicted in FIG. 1B, encoder device 30 is a rigid encoder element disposed to revolve about axis S-S within drum housing 16. As described further hereinafter, encoder device 30 rotates under torque applied by fluid flow through sensor system 10, providing an indicator of flow rate. Encoder device 30 can be one color, consist of one material, or otherwise have a uniform appearance. Encoder device 30 can be, for example, a spherical ball or torus, or portion thereof, and can be one color and made of one material.

Splines 18 extend from display housing 14 to support and stabilize display housing 14 above drum housing 16. Clips 20 secure drum housing 16 about central passage 22 such that drum housing 16 is connected to central passage housing 23. Central passage 22 extends axially within sensor system 10 with respect to axis S-S.

As described in more detail below, fluid flows through drum housing 16 along the vortex flow path 24 defined by interior walls 32 and inner surface 33 such that the fluid is directed to travel in the vortex flow path around central passage 22. The fluid then is directed into central passage 22 and flows in the opposite direction to eventually be routed out of the sensor system 10 (e.g., to a spray nozzle). Optical sensor 26 is configured to emit a light beam to detect one or more targets and can include a source, such as source 27, which emits the light beam. Source 27 can be an LED configured to emit a light beam in the infrared light range (i.e., a light beam having a wavelength of between approximately 700 nanometers and approximately 1 millimeter). The one or more targets can be, for example, encoder device 30, which rotates within drum housing 16 as fluid passes through sensor system 10. Optical sensor 26 is also configured to receive the light beam after the light beam is reflected off the target and can include a detector, such as detector 29, which receives the light beam. Detector 29 can be a photodiode capable of receiving infrared light. Optical sensor 26 can be further configured to communicate data about the reflected light beam to controller 39. Controller 39 can be a processor. Controller 39 and optical sensor 26 can form one component, or controller 39 can be separate from optical sensor 26. Controller 39 can be configured to generate transmittance data and absorption data about the fluid and the target. Controller 39 can be further configured to assess the speed of the target and calculate a flow rate of the fluid within drum housing 16. In this way, optical sensor 26 and controller 39 can detect and analyze the movement of a target, such as encoder device 30, within drum housing 16. Controller 39 can be further configured to communicate with a display, such as display 37, the flow rate of the fluid along vortex flow path 24, and display 37 can be configured to display the flow rate of the fluid along vortex flow path 24. In some examples, optical sensor 26 can be configured to communicate data about the reflected light beam to an oscilloscope 41. Oscilloscope 41 and display 37 and/or controller 39 can form one component, or oscilloscope 41 can be separate from both display 37 and controller 39.

During operation of sensor system 10, fluid flows through optical sensor section 12. Fluid enters first end 34 of drum housing 16 and flows in a direction parallel to axis S-S (i.e., along the first flow path). The fluid then is directed in the vortex flow path 24 by interior walls 32. This vortex flow path 24 is characterized by having both an axial component (towards second end 36 of drum housing 16) and a circumferential component (about inner circumference 38 of drum housing 16, shown in FIG. 5A). The interior geometry of drum housing 16 (i.e., interior walls 32) and the exterior of central passage housing 23 together define the vortex flow path 24 that pre-vortexes fluid incident upon encoder device 30. As a consequence of the vortexing geometry of interior walls 32, fluid contacts encoder device 30 at a vector velocity with a substantial circumferential component, improving responsiveness (i.e., revolution about axis S-S) of encoder device 30 at high and low fluid flow rates. More specifically, this vortexing increases torque on encoder device 30, helping to more readily overcome static friction to rotate encoder device 30 even at low fluid flow rates. The fluid arrives at second end 36, flows into central passage 22, and flows through central passage 22 towards first end 34. The fluid can then be routed to an outlet of sensor system 10, such as a spray nozzle. The movement of fluid through optical sensor section 12 drives the revolution of encoder device 30 about axis S-S by moving encoder device 30 along the portion of the vortex flow path 24 illustrated by inner circumference 38.

U.S. Patent Application Publication 2023/0025158A1 , “Spray Flow Sensing with Optical Signature Analysis,” published Jan. 26, 2023, discloses that certain encoder devices may not work to detect flow rates for all fluids, due to optical properties of fluids (which can vary with composition) and of the encoder device. One solution is to use an encoder device having two or more parts with different optical properties, as shown in FIGS. 6A-7 of WO 2023/002263 A1.

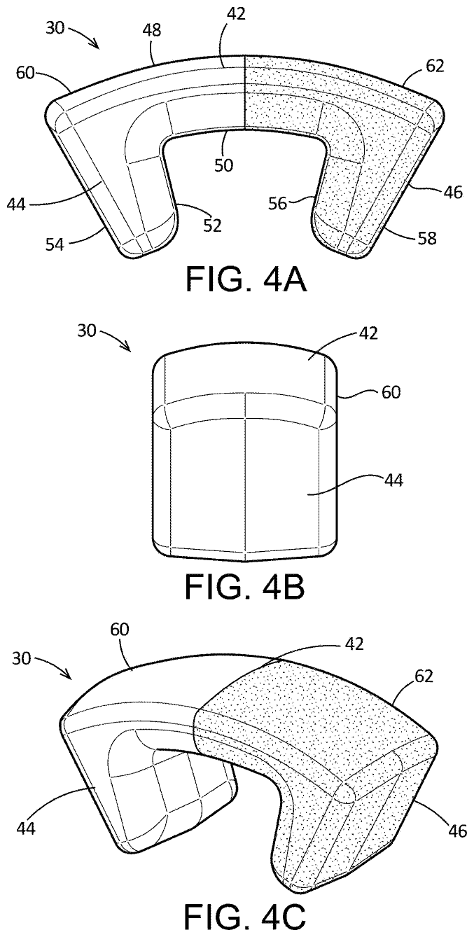

FIG. 3A is a rear perspective view of optical sensor section 12 and drum housing 16. FIG. 3B is a perspective cutaway view of the optical sensor section 12 showing the encoder device 30 therein. FIGS. 4A-4C illustrate the encoder device 30 alone. FIG. 4A is side view of the encoder device 30; FIG. 4B is an end view of the encoder device 30; and FIG. 4C is a perspective view of the encoder device 30. Encoder device 30 includes opaque section 132 and translucent section 134.

Optical sensor section 12 and drum housing 16 have the structure and design as discussed above in reference to FIGS. 1A-2. In the depicted embodiment, encoder device 30 is a bi-sectional encoder device. The encoder device 30 includes a unitary body having a main portion 42, a first tab portion 44, and a second tab portion 46. The portions 42, 44, 46 together form the overall shape of the encoder device 30. The main portion 42 has a first arcuate surface 48 on a first side (i.e., the exterior, in reference to the axis S-S around which the encoder device 30 revolves, depicted in FIG. 3A) and a second arcuate surface 50 on a second side (i.e., the interior) of the encoder device 30. The first tab portion 44 has a first inner surface 52 and a first outer surface 54. The second tab portion 46 has a second inner surface 56 and a second outer surface 58. The inner surfaces 52, 56 face one another and extend from the second (interior) arcuate surface 50 of the main portion 42 toward the axis S-S. Thus, the second (interior) arcuate surface 50 of the main portion 42 extends from the first inner surface 52 to the second inner surface 56. The outer surfaces 54, 58 extend from the first (exterior) arcuate surface 48 of the main portion 42 toward the axis S-S.

The inner surfaces 52, 56 and the outer surfaces 54, 58 may each be generally planar and oriented in a common plane with the axis S-S. That is, the inner surfaces 52, 56 may define an angle at the point they would intersect, which is the axis S-S. The outer surfaces 54, 58 may also define an angle at that point. Both angles may be acute. For example, the angle defined by the outer surfaces 54, 58 may be from about 30° to about 135°, such as from about 35° to about 50°, or about 45°. If the angle defined by the outer surfaces 54, 58 is 45°, then the encoder device 30 forms an arc which is approximately one-eighth (approximately 12%) of inner circumference 38 of drum housing 16. The angle defined by the inner surfaces 52, 56 may be from about 10° to about 90°, such as from about 15° to about 40°, or about 25°.

The encoder device 30 may include two different sections 60, 62 having different optical properties, such as transmittance, absorbance, or reflectance at a preselected wavelength. For example, one section 60 may be translucent, and the other section 62 may be opaque to the preselected wavelength. The sections 60, 62 can each make up approximately one half of encoder device 30 such that approximately one half of encoder device 30 is opaque and approximately one half of encoder device 30 is translucent. During operation of the sprayer, the encoder device 30 revolves around axis S-S. Other designs of bi-sectional encoder devices are possible, such as an encoder device which is half black and half white, half opaque and half transparent, and other possible combinations. Furthermore, in some embodiments, the main portion 42 may be one color (or other optical property), the first tab portion 44 may be another color, and the third tab portion 46 may be yet another color.

In some embodiments, the sections 60, 62 (and therefore the tab portions 44, 46) may have different material compositions, selected such that the sections 60, 62 have preselected optical properties. The materials may be of any selected type, such as plastics, ceramics, metals, etc., and combinations thereof. The materials may be selected to have other physical properties in common. For example, the materials of the sections 60, 62 may have densities within about 5% of each other, such as within about 1%, or even within about 0.5% of each other, to limit the effect of different densities on the movement of the encoder device 30.

When fluid flows through the sensor system 10, encoder device 30 travels along a portion of the vortex flow path 24 such that encoder device 30 revolves around axis S-S along the inner circumference of drum housing 16. A portion of the vortex flow path 24 is represented by arrow 40 shown in FIG. 3A. As described above in reference to FIGS. 1A-2, the flow of fluid through drum housing 16 causes the rotation of encoder device 30 about axis S-S. Fluid impinges against encoder device 30 and causes movement of encoder device 30. Interior walls 32 can be configured to allow encoder device 30 to rotate within a particular section of drum housing 16 and prevent movement of encoder device 30 to points further downstream.

The opaque section 62 has a higher optical absorption value than translucent section 60, which generates a distinct optical signature and raises the signal-to-noise ratio relative to a uniform encoder device, as described in more detail in U.S. Patent Application Publication 2023/0025158A1 . This enables the sensor system 10 to better measure flow rates of liquids having various optical properties (e.g., different solids loading). Furthermore, the shape of the encoder device 30 shown in FIGS. 3A-4C may improve measurement quality by reducing drag and mass, as compared to certain other encoder devices. Because the encoder device 30 is “notched” (i.e., missing a section in the center as compared to the encoder devices 130, 230 shown in FIGS. 6A-7 of WO 2023/002263 A1), the encoder device 30 may have lower mass and increased surface area. Thus, the encoder device 30 may be less susceptible to body forces (e.g., buoyancy and the rate of change of momentum) as compared to prior encoder devices, and more susceptible to viscous forces (i.e., the force of fluid on the encoder device). The addition of the center notch may also reduce the suctioning effect to exhaust ports of the drum housing 16. Without this notch, and under certain operating conditions, frequency losses were observed over an extended observation period.

The sensor system 10 senses the revolution of the encoder device 30 using the source 27 and optical sensor 26 in various working mediums, with low signal-to-noise ratios.

The use of multiple materials or optical properties increases the envelope of working mediums. As one section 60, 62 of the encoder device 30 develops a low signal-to-noise ratio, the material of another section 62, 60 can generate a signal-to-noise ratio within detection limits. This design reduces or eliminates sensor operability and dependency upon the optical properties of the fluid being measured.

Using a multi-sectional encoder device within an optical sensor system for a sprayer provides several advantages. The use of an encoder device allows measurement of the flow rate through the sprayer using an optical sensor. The multi-sectional encoder device facilitates accurate readings across a range of fluid opacities and allows for precise calibration of the optical sensor. Revolution of the encoder device is facilitated (especially at low and high fluid flow rates) by pre-vortexing of fluid via vortexing geometry of interior walls upstream of the encoder device. This pre-vortexed flow contacts the encoder device along a partially circumferential vector. The pre-vortexed flow efficiently drives the encoder device and enables the optical sensor as a whole to generate accurate measurements of flow rate using the encoder device (which is more reliable than with unvortexed, purely axial fluid flow). Because a tri-sectional encoder device will produce a different optical signature than a bi-sectional encoder device, the use of a tri-sectional encoder device can facilitate more accurate sensor calibration in some applications. Finally, the use of a multi-sectional encoder device is cost-effective and increases ease of use of the optical sensor system.

All references cited herein are incorporated herein in their entireties. If there is a conflict between definitions herein and in an incorporated reference, the definition herein shall control.

1. A rotary optical encoder device comprising a unitary body, the body comprising:
a main portion defining a first arcuate surface on a first side of the main portion and a second arcuate surface on a second opposite side of the main portion;
a first tab portion extending from the second opposite side of the main portion proximate a first longitudinal end of the main portion, the first tab portion having a first inner surface and a first outer surface, the first outer surface extending from the first arcuate surface at the first longitudinal end of the main portion; and
a second tab portion extending from the second opposite side of the main portion proximate a second longitudinal end of the main portion, the second tab portion having a second inner surface and a second outer surface, the second outer surface extending from the first arcuate surface at the second longitudinal end of the main portion;
wherein the second arcuate surface of the main portion extends between the first inner surface and the second inner surface.

2. The encoder device of claim 1, wherein the first tab portion has a first transmittance at a preselected wavelength and the second tab portion has a second transmittance at the preselected wavelength, the second transmittance different from the first transmittance.

3. The encoder device of claim 1, wherein the first tab portion has a first reflectance at a preselected wavelength and the second tab portion has a second reflectance at the preselected wavelength, the second reflectance different from the first reflectance.

4. The encoder device of claim 1, wherein the first outer surface and the second outer surface define an acute angle therebetween.

5. The encoder device of claim 1, wherein the first inner surface and the second inner surface define an acute angle therebetween.

6. The encoder device of claim 1, wherein the first inner surface faces the second inner surface.

7. The encoder device of claim 1, wherein the first tab portion comprises a first material having a first composition and the second tab portion comprises a second material having a second composition different from the first composition.

8. The encoder device of claim 7, wherein the first material and the second material are each selected from the group consisting of plastics, ceramics, and metals.

9. The encoder device of claim 7, wherein the first material comprises an opaque material and the second material comprises a translucent material.

10. An optical flow rate sensor system for an agricultural sprayer, the system comprising:
a drum housing and a central passage housing together defining a first flow path comprising a first portion generally parallel to an axis and a second vortex portion around the axis;
an optical sensor disposed facing the axis; an optical sensor window within a display housing and disposed between the axis and the optical sensor; and
the encoder device of claim 1 within the drum housing and configured to revolve around the axis when fluid flows through the first flow path.

11. The optical flow rate sensor system of claim 10, wherein the central passage housing defines a second flow path generally parallel to, and in an opposite direction of, the first flow path.

12. The optical flow rate sensor system of claim 10, wherein the drum housing comprises:
an inner surface; and
at least one interior wall which extends from the inner surface;
wherein the interior wall extends circumferentially about a circumference of the inner surface and axially parallel to the axis such that the at least one interior wall defines the second vortex portion of the first flow path.

13. A method of testing an optical flow rate sensor system for an agricultural sprayer, the method comprising:
directing, with a drum housing and a central passage housing, a fluid along a vortex flow path within the drum housing and around an axis;
revolving the encoder device of claim 1 within the drum housing and around the axis;
emitting, with an optical sensor, a light beam through an optical sensor window, through the fluid, and toward the axis;
reflecting a portion of the light beam by the encoder device;
receiving, with the optical sensor, the portion of the light beam reflected by the encoder device;
communicating, with the optical sensor, data about the reflected light to a controller;
generating, with the controller, transmittance data and absorption data about the fluid and the encoder device; and
assessing, with the controller, a speed of the encoder device about the axis to calculate a flow rate of the fluid along the vortex flow path.

14. The method of claim 13, wherein directing, with the drum housing and central passage housing, the fluid along the vortex flow path and around the axis, comprises directing the fluid along the vortex flow path such that the fluid drives revolution of the encoder device around the axis within the drum housing.

15. The method of claim 13, wherein:
reflecting a portion of the light beam by the encoder device comprises reflecting the light beam by a first section of the encoder device and a second section of the encoder device, wherein the first section has a first optical absorption value and the second section has a second optical absorption value that is different from the first optical absorption value; and
generating, with the controller, transmittance data and absorption data about the fluid and the encoder device comprises generating at least one of transmittance data and absorption data about each of the first section and the second section.

16. The method of claim 13, wherein generating, with the controller, transmittance data and absorption data about the fluid and the encoder device comprises analyzing an optical signature of the encoder device.

17. The method of claim 16, wherein analyzing the optical signature of the encoder device comprises communicating, with the optical sensor, data about the portion of the light beam reflected by the encoder device to an oscilloscope.

18. The method of claim 13, further comprising communicating, with the controller, the flow rate of the fluid along the vortex flow path, to a display.

19. The method of claim 18, further comprising displaying, with the display, the flow rate of the fluid along the vortex flow path.
